(19) United States
(12) Patent Application Publication
(10) Pub. No.: US 2005/0152639 A1
(43) Pub. Date: Jul. 14, 2005

(54) Optical switch and fabrication method thereof

(76) Inventors: Hyun Kee Lee, Suwon (KR); Sang Kee Yoon, Suwon (KR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/857,962

(22) Filed: Jun. 2, 2004

(30) Foreign Application Priority Data
Jan. 9, 2004 (KR) 2004-1360

(51) Int. Cl. G02B 6/26

(52) U.S. Cl. 385/18

(57) ABSTRACT

The invention relates to an optical switch and a fabrication method thereof. In the invention, a base layer has input terminals for receiving optical signals and output terminals for selectively receiving the optical signals from the input terminals to transmit the optical signals to the outside. Micro mirrors are movably placed on optical signal paths of the optical signals received from the input terminals of the base layer, respectively, in a direction intersecting with an optical signal to selectively reroute the optical signal from a first optical path to a second optical path. MEMS actuators are formed in a layer above the optical signal paths and connected with the micro mirrors, respectively, to drive the micro mirrors in the direction intersecting with the optical signals.

### CLAIM OF PRIORITY

This application claims the benefit of Korean Patent Application No. 2004-1360 filed on Jan. 9, 2004, in the Korean Intellectual Property Office, the disclosure of which is incorporated herein by reference.

### BACKGROUND OF THE INVENTION

1. Field of the Invention

The present invention relates to an optical switch and a fabrication method thereof, more particularly, capable of forming a two stage structure of micro mirrors and actuators of different thickness in order to facilitate a fabrication process. Further, the optical switch and the fabrication method thereof of the present invention can shorten optical paths thereby to improve the degree of integrity and overall light transmission characteristics.

2. Description of the Related Art

As well known in the art, a Matrix Optical Switch (M-OSW) is a core component of the optical communication technology. The matrix optical switch has a matrix of N number of input terminals and N number of output terminals by which an optical signal inputted via a specific input terminal is rerouted to a desired output terminal. Up to the present, an optical switch of this type has converted an input optical signal through an input terminal into an electric signal to execute signal processing and then again into an optical signal before routing the same to an output terminal.

Recently new techniques for realizing matrix optical switches were developed based upon the Micro Electro-Mechanical System (MEMS) technology which uses micro mirrors and micro actuators to reroute optical signals introduced via input terminals without converting the optical signals into electric ones. Such MEMS matrix optical switches show a switching speed faster than that of the OEO type matrix optical switches.

FIG. 1 is a plan view illustrating a conventional MEMS matrix optical switch, and FIG. 2 is a sectional view of the optical switch shown in FIG. 1.

As shown in FIGS. 1 and 2, the conventional MEMS matrix optical switch includes N number of input optical fibers 101 and N number of output optical fibers 103. The input and output optical fibers 101 and 103 are arrayed together with N×N number of micro mirrors 116 in the same layer above an actuator substrate 110. Lenses 102 and 104 for steering light beams parallel are connected to front ends of the optical fibers 101 and 103 in order to prevent light loss by the dispersion of light in the input and output optical fibers 101 and 103. Since the lenses 102 and 104 have a diameter larger than that of the optical fibers, they increase the diameter of light, and thus the size of the micro mirrors 116 for rerouting light.

Further, the actuators for driving the micro mirrors 116 are provided above the substrate 110 and with fixing sections 115 and drive sections 114, and simultaneously formed from an equal structure layer with the micro mirrors 116. Therefore, the actuators have the same thickness as the micro mirrors 116. In this case, because the micro mirrors 116 and the actuators are formed together with light paths 107 on a plane of the same height, it is required to ensure spaces for the light paths 107 between the actuators. Accordingly, it is difficult to reduce the size of the optical switch or the light loss because the light paths are almost impossible to be shortened. Also, owing to the overall size restriction, it is impossible to improve the degree of integrity by increasing channel number.

In addition, regarding the aspect of a fabrication process, there is another problem in that the actuators have etching characteristics and desired etching level different from those of the micro mirrors. That is, the actuators are to be processed into a more compact and complicated configuration than the micro mirrors. Accordingly, specific regions of a structure to be etched into the actuators are significantly different in width and area from those regions to be etched into the micro mirrors. In particular, in comb actuators each having opposed comb members, the etching width and area of comb regions to be formed into the comb members shows great difference from that of micro mirror regions to be formed into the micro mirrors.

In this case, the actuator-forming regions are etched at a width smaller than that of the micro mirror-forming regions so that etchant gas may not efficiently flow or diffuse during etching. Then, the etching rate per unit time of the actuators becomes smaller than that of the micro mirrors in a depth direction. The micro mirrors-forming regions are etched at a larger width so that reactant gas is introduced and diffused rapidly, and thus their etching rate is higher than that of the actuator-forming regions. Regarding the above situations that the actuators have lower etching rate, etching is carried out under process conditions of high etching rate in order to form the actuators and the micro mirrors in the same layer. However, etching carried out at high etching rate causes a serious problem in that the side walls of the micro mirrors are damaged because they are gradually roughened in proportion to the etching rate and exposed to etchant gas for a long time. There is another problem in that an etching mask is required to be thick and hard in order to withstand the process conditions of long etching time and high etching rate that are determined for the purpose of etching the actuators of lower etching rate.

If the etching mask is not thick or hard, etched regions cannot maintain their shape under those process conditions of high etching rate and long etching time, thereby failing to form a desired configuration. However, increasing the thickness and hardness of the etching mask also restricts the selectivity of the etching mask and lowers the precision of an etching pattern.

Accordingly, various researches have been continuously made in the art in order to overcome those problems induced from the foregoing structure and process.

### SUMMARY OF THE INVENTION

The present invention has been made to solve the foregoing problems of the prior art and it is therefore an object of the present invention to provide an optical switch having actuators and micro mirrors formed in different layers to reduce its size, increase channel number and shorten optical paths thereby decreasing the transmission loss of light.

It is another object of the present invention to provide a fabrication method of an optical switch capable of forming actuators and micro mirrors in different layers to easily fabricate the optical switch as well as improve characteristics of structural elements produced thereby.

According to an aspect of the invention for realizing the above objects, there is provided an optical switch comprising: a base layer having input terminals for receiving optical signals and output terminals for selectively receiving the optical signals from the input terminals to transmit the optical signals to the outside; micro mirrors movably placed on optical signal paths of the optical signals received from the input terminals of the base layer, respectively, each of the micro mirrors being movable in a direction intersecting with an optical signal to selectively reroute the optical signal from a first optical path to a second optical path; and Micro Electro-Mechanical System (MEMS) actuators formed in a layer above the optical signal paths and connected with the micro mirrors, respectively, to drive the micro mirrors in the direction intersecting with the optical signals.

Preferably, the base layer is provided with support structures of a predetermined height so that the MEMS actuators are seated on the support structures without interfering with the optical signal paths.

Preferably, the input terminals comprise N number of optical fibers arrayed at a fixed interval, the output terminals comprise N number of optical fibers arrayed at a fixed interval, and both the micro mirrors and the MEMS actuators are provided in the form of an N×N matrix to correspond to the input and output terminals.

It is preferable that the micro mirrors have an initial position for reflecting the optical signals propagating along the optical signal paths, and are movable from the initial position toward the MEMS actuators when pulled through the operation of the MEMS actuators.

It is also preferable that the MEMS actuators comprise comb actuators.

According to another aspect of the invention for realizing the above objects, there is provided an optical switch comprising: a base layer having input terminals of N number of optical fibers for receiving optical signals and output terminals of N number of optical fibers for selectively receiving the optical signals from the input terminals to transmit the optical signals to the outside; N×N number of micro mirrors movably placed on portions intersected by first optical signal paths extending from the input terminal optical fibers and second optical signal paths extending from the output terminal optical fibers, respectively, each of the micro mirrors being movable in a direction intersecting with an optical signal to selectively reroute the optical signal from a first optical path to a second optical path; and an actuation layer having N×N number of Micro Electro-Mechanical System (MEMS) actuators formed above the optical signal paths and connected with the micro mirrors, respectively, to drive the micro mirrors in the direction intersecting with the optical signals.

Preferably, the base layer is provided with support structures of a predetermined height so that the actuation layer is seated on the support structures without interfering with the optical signal paths.

Preferably, the micro mirrors have an initial position for reflecting the optical signals propagating along the optical signal paths, and are movable from the initial position toward the MEMS actuators when pulled through the operation of the MEMS actuators.

It is preferable that the MEMS actuators comprise comb actuators.

According to another aspect of the invention for realizing the above objects, there is provided a fabrication method of an optical switch comprising the following steps of:
etching a glass wafer to form support structures;
preparing a Si wafer;
etching the Si wafer to form micro mirrors;
bonding the Si wafer on the glass wafer so that the micro mirrors of the Si wafer are placed between the support structures of the glass wafer;
etching the Si wafer to form the MEMS actuators; and
arraying input and output terminal optical fibers so that an optical signal can propagate between the support structures of the glass wafer.

Preferably, the support structures are formed at a predetermined height so that the MEMS actuators do not interfere with optical signal paths.

Preferably, the input terminal optical fibers comprise N number of optical fibers arrayed at a fixed interval, the output terminal optical fibers comprise N number of optical fibers arrayed at a fixed interval, and both the micro mirrors and the MEMS actuators are provided in the form of an N×N matrix to correspond to the input and output terminal optical fibers.

It is preferred that the MEMS actuators comprise comb actuators.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a plan view illustrating a conventional MEMS based matrix optical switch;

FIG. 2 is a sectional view of the optical switch shown in FIG. 1;

FIG. 3 is a plan view illustrating an optical switch of the invention;

FIG. 4 is a sectional view of the optical switch of the invention; and

FIGS. 5A to 5H are stepwise sectional views illustrating a fabrication method of an optical switch of the invention.

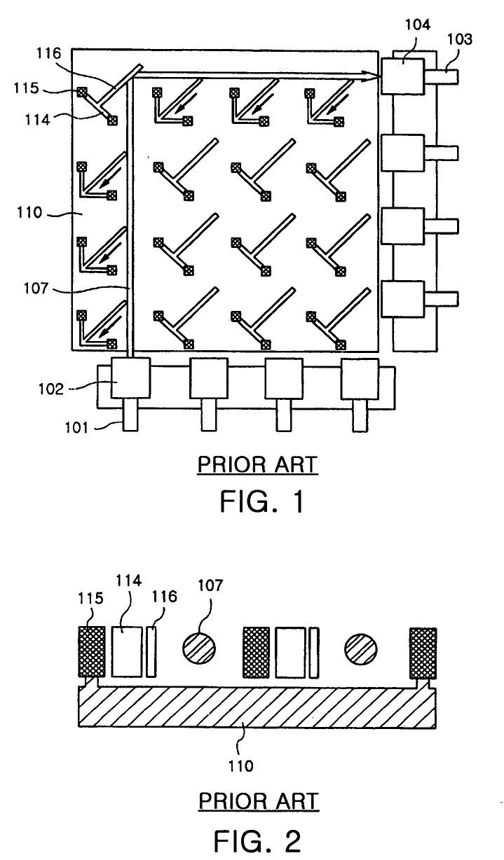

### DETAILED DESCRIPTION OF THE PREFERRED EMBODIMENT

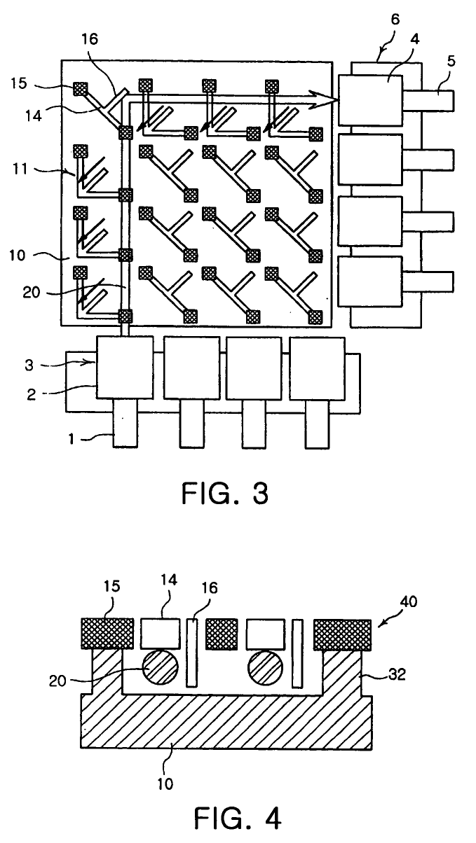

Hereinafter a preferred embodiment of the present invention will now be described in detail with reference to the accompanying drawings, in which FIG. 3 is a plan view illustrating an optical switch of the invention, and FIG. 4 is a sectional view of the optical switch of the invention.

The optical switch of the invention is so designed that micro mirrors placed on optical paths in a direction intersecting with optical signals can be shifted by actuators that are placed in a layer different from that of the optical paths in order to raise integrity.

In FIG. 3, the optical switch includes optical signal input terminals 3 and optical signal output terminals 6 formed on a base layer 10. The optical signal input terminals 3 include n number of optical fibers 1 arrayed at a predetermined gap, and lenses 2 for preventing diffusion of optical signals are connected to ends of the optical fibers 1. Likewise, the output terminal 6 include N number of optical fibers 5 with the same number as the optical fibers 1 in the input terminal 3, and lenses 4 are formed at ends of the optical fibers to concentrate optical signals propagated from the input terminals 3. The output terminals 6 serve to selectively receive optical signals from the input terminal 3 to transfer the same to the outside.

Optical fibers of the input and output terminals are fiber optic products that are mainly made from glass of excellent transparency, or sometimes, synthetic resin. An optical fiber has a double cylindrical configuration with a core in the center and an outside cladding surrounding the core. A synthetic resin coating is applied on the outside face of the optical fiber to prevent the optical fiber from external impact. The core of the optical fiber has a predetermined index of refraction higher than the cladding so that an optical signal can be concentrated on the core to propagate along the optical fiber without loss.

On the base layer 10, there are formed optical signal paths 20 for guiding optical signals inputted through the input terminals 3. The optical signal paths 20 indicate spaces for permitting the optical signals to propagate without any interference. There are micro mirrors 16 arrayed on the optical signal paths 20, movable in a direction crossing the optical signals.

The micro mirrors 16 reflect input optical signals rerouting the same toward the output terminals 6. Each micro mirror 16 is contacted at one free end with an optical signal and connected at the other end above the free end to an actuator for driving the micro mirror 16.

There are provided a plurality of actuators 11 for driving the micro mirrors 16 are of Micro Electro Mechanical System (MEMS) actuators.

The MEMS actuators are of microscopic drive means, each of which has a drive structure formed in a silicon wafer via etching, and executes microscopic actuation when voltage is applied to the drive structure. The micro mirrors 16 are formed integrally with the MEMS actuators.

The MEMS actuators 11 are formed on actuation layer 40 that is arranged above the optical signal paths 20. As shown in FIG. 4, the actuation layer 40 is placed above an optical signal path 20, and a micro mirror 16 is formed in regions corresponding from an optical signal path 20 to the actuation layer 40. The micro mirror 16 is connected at the top with a drive section 14 of a corresponding MEMS actuator. The actuation layer 40 forms itself into the drive sections 14 and fixing sections 15 for securing the drive sections 14 which constitute the MEMS actuators 11.

A fixing section 15 of each MEMS actuator 11 is provided with a terminal (not shown) for receiving voltage, which is in turn applied from the terminal to the MEMS actuator 11 powering the same. The MEMS actuator is preferably of a comb actuator.

N×N number of the micro mirrors 16 and the actuators 11 are arrayed corresponding to the number of the optical fibers 1 and 5 arranged in the input and output terminals 3 and 5, respectively. That is, the micro mirrors 16 and the actuators 11 form a matrix of N number of rows and columns.

On the base layer 10, support structures 32 as shown in FIG. 4 are projected upward, and optical paths are formed between the support structures 32, respectively. The drive sections 14 for forming the micro mirrors 16 and the actuators 11 and the actuation layer 40 for forming the fixing sections 15 are placed on the support structures 32, respectively.

As shown in FIG. 3, the micro mirrors 16 are initially arrayed on the optical signal paths to reflect optical signals in such a fashion that the micro mirrors can be pulled in response to the operation of the actuators to form the optical signal paths. The actuators may be of comb actuators, and so structured to pull the micro mirrors in the direction of arrows as shown in FIG. 3 upon application of voltage.

The optical switch of the invention is characterized in that the actuators are formed in a different layer from the optical signal paths unlike the prior art in which actuators are formed flush with optical signal paths. Therefore, the micro mirrors 16 are formed along two layers from the top of the base layer 10 to the actuation layer 40.

Because the actuators are not formed in the base layer 10 according to the optical switch of the invention, there is an advantage in that those regions for forming the actuators can be omitted.

That is, the interval between the optical signal paths can be decreased unlike the prior art. This can be obtained by the actuators separately formed in the actuation layer above the base layer. As a result, the optical switch of the invention can be formed at a smaller size than conventional optical switches having the same number of channels. Also, the optical switch can be designed to have more channels than conventional optical switches of the same size.

Further, according to the structure of the invention, it is possible to shorten the optical signal paths. That is, if the channels are arrayed in the same number as the prior art, the interval between the optical signal paths in the base layer is decreased thereby to shorten the optical signal paths from the input terminals to the output terminals. This structure can advantageously prevent the transmission loss of optical signals.

Also, it is essential for the prior art to apply separate electric signals for respective channels because the actuators are formed in the same layer as the optical signal paths. According to the invention, however, the actuators are formed above the optical signal paths, and terminals for applying voltage to the actuators are also formed above the optical fibers. This as a result provides an advantage of improving the design flexibility of the terminals of the respective channels and the respective patterns connected thereto.

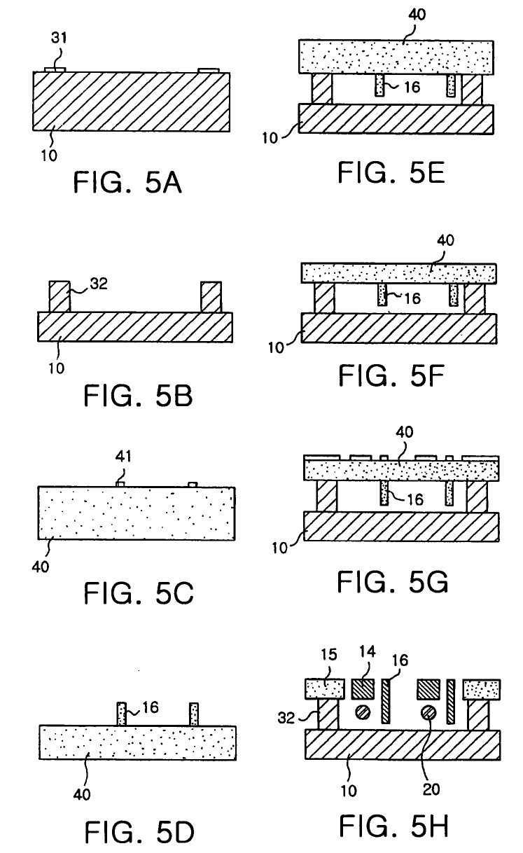

FIGS. 5A to 5H are stepwise sectional views illustrating a fabrication method of an optical switch according to the invention, as will be now described in a stepwise manner.

First, a glass wafer to be formed into a base layer 10 of an optical switch is prepared. It is preferred that the wafer is made of glass, and more particularly, transparent glass so that the actuators can be easily arrayed. On the glass wafer 10, there is formed a pattern 31 to be used as an etching mask. The pattern may be formed of for example a dry film resist (FIG. 5A).

The glass wafer is then etched according to the pattern 31 to form support structures 32. The support structures 32 are formed to support an actuation layer 40, and optical signal paths are formed between the support structures 32 (FIG. 5B). The support structures 32 are preferably formed at a height enough to prevent the actuators 14 from interfering with the optical signal paths formed in the base layer.

After the formation of the base layer 10 having the support structures 32, a separate wafer 40 is prepared (FIG. 5C). An etching pattern 41 forming a micro mirror 16 is formed on the wafer 40, and the wafer 40 is etched according to the etching pattern 41 to form the micro mirror 16 of a predetermined area (FIG. 5D).

The Si wafer 40 provided with the micro mirror 16 as above is turned upside down, and then bonded to the top of the support structures 32 of the glass wafer 10 (FIG. 5E).

Then, the micro mirror 16 is positioned on the optical signal path 20 that is formed between the support structures. Further, the bonded Si wafer 40 is polished to a predetermined thickness (FIG. 5F).

An etching pattern 51 is formed on the top of the Si wafer 40 to form an MEMS actuator. Then, the Si wafer 40 is etched according to the etching pattern 51 to form a drive section 14 and a fixing section 15 in such a fashion that the micro mirror 16 is connected with the drive section 14 (FIGS. 5G and 5H).

This step also forms terminals and other patterns for applying voltage to the actuator. The actuator is preferably of a comb actuator.

After the glass wafer of the base layer and the Si wafer of the actuation layer placed above the glass wafer are fabricated as above, input and output terminal optical fibers are arranged between the support structures of the glass wafer so that an optical signal can propagate through the same. Since the optical fibers of input and output terminals are arrayed by the N number of channels, respectively, the Si wafer 40 of the actuation layer is provided with N×N number of actuators and micro mirrors.

The fabrication method of an optical switch according to the invention separately forms a base layer having optical signal paths and an actuation layer placed above the base layer. This as a result avoids those problems caused by different etching characteristics when the micro mirrors and the actuators are simultaneously formed in the same layer. That is, regarding the above situations that the actuators have lower etching rate, etching is carried out under process conditions of high etching rate in order to form the actuators and the micro mirrors in the same layer. However, etching carried out at high etching rate causes a serious problem in that the side walls of the micro mirrors are damaged because they are gradually roughened in proportion to the etching rate and exposed to etchant gas for a long time. There is another problem in that an etching mask is required to be thick and hard in order to withstand the process conditions of long etching time and high etching rate that are determined for the purpose of etching the actuators of lower etching rate.

However, according to the invention, the micro mirrors are first formed in the actuation layer, which is placed on the base layer in an overturned position to form the actuators. That is, the actuators and the micro mirrors are formed in separate process steps, by which the micro mirrors are formed independently from the etching conditions of the actuators, and thus problems such as surface damage can be prevented.

In the prior art, the micro mirrors are movable only if their thickness is the same as that of the actuators because the micro mirrors and the actuators are simultaneously formed in the same layer. According to the invention, the micro mirrors can be formed with a thickness (or a vertical height) different from that of the actuators. More preferably, the actuators can be formed sufficiently thin to advantageously shorten fabrication time, raise operation efficiency, and reduce the thickness of the mask pattern in the etching step.

According to the present invention as set forth above, the actuators and the micro mirrors formed in different layers to reduce the size of the optical switch, increase channel number and shorten optical paths thereby decreasing the transmission loss of light.

Further, in the fabrication method of an optical switch, the actuators and micro mirrors are formed in different layers according to separate processes to facilitate the fabrication process of an optical switch as well as improve characteristics of structural elements produced thereby.

While the present invention has been shown and described in connection with the preferred embodiments, it will be apparent to those skilled in the art that modifications and variations can be made without departing from the spirit and scope of the invention as defined by the appended claims.

1. An optical switch comprising:
a base layer having input terminals for receiving optical signals and output terminals for selectively receiving the optical signals from the input terminals to transmit the optical signals to the outside;
micro mirrors movably placed on optical signal paths of the optical signals received from the input terminals of the base layer, respectively, each of the micro mirrors being movable in a direction intersecting with an optical signal to selectively reroute the optical signal from a first optical path to a second optical path; and
Micro Electro-Mechanical System (MEMS) actuators formed in a layer above the optical signal paths and connected with the micro mirrors, respectively, to drive the micro mirrors in the direction intersecting with the optical signals.

2. The optical switch according to claim 1, wherein the base layer is provided with support structures of a predetermined height so that the MEMS actuators are seated on the support structures without interfering with the optical signal paths.

3. The optical switch according to claim 1, wherein the input terminals comprise N number of optical fibers arrayed at a fixed interval, the output terminals comprise N number of optical fibers arrayed at a fixed interval, and both the micro mirrors and the MEMS actuators are provided in the form of an N×N matrix to correspond to the input and output terminals.

4. The optical switch according to claim 1, wherein the micro mirrors have an initial position for reflecting the optical signals propagating along the optical signal paths, and are movable from the initial position toward the MEMS actuators when pulled through the operation of the MEMS actuators.

5. The optical switch according to claim 1, wherein the MEMS actuators comprise comb actuators.

6. An optical switch comprising:
a base layer having input terminals of N number of optical fibers for receiving optical signals and output terminals of N number of optical fibers for selectively receiving the optical signals from the input terminals to transmit the optical signals to the outside;
N×N number of micro mirrors movably placed on portions intersected by first optical signal paths extending from the input terminal optical fibers and second optical signal paths extending from the output terminal optical fibers, respectively, each of the micro mirrors being movable in a direction intersecting with an optical signal to selectively reroute the optical signal from a first optical path to a second optical path; and
an actuation layer having N×N number of Micro Electro-Mechanical System (MEMS) actuators formed above the optical signal paths and connected with the micro mirrors, respectively, to drive the micro mirrors in the direction intersecting with the optical signals.

7. The optical switch according to claim 6, wherein the base layer is provided with support structures of a predetermined height so that the actuation layer is seated on the support structures without interfering with the optical signal paths.

8. The optical switch according to claim 6, wherein the micro mirrors have an initial position for reflecting the optical signals propagating along the optical signal paths, and are movable from the initial position toward the MEMS actuators when pulled through the operation of the MEMS actuators.

9. The optical switch according to claim 6, wherein the MEMS actuators comprise comb actuators.

10. A fabrication method of an optical switch comprising the following steps of:
etching a glass wafer to form support structures;
preparing a Si wafer;
etching the Si wafer to form micro mirrors;
bonding the Si wafer on the glass wafer so that the micro mirrors of the Si wafer are placed between the support structures of the glass wafer;
etching the Si wafer to form the MEMS actuators; and
arraying input and output terminal optical fibers so that an optical signal can propagate between the support structures of the glass wafer.

11. The fabrication method of an optical switch according to claim 10, wherein the support structures are formed at a predetermined height so that the MEMS actuators do not interfere with optical signal paths.

12. The fabrication method of an optical switch according to claim 10, the input terminal optical fibers comprise N number of optical fibers arrayed at a fixed interval, the output terminal optical fibers comprise N number of optical fibers arrayed at a fixed interval, and both the micro mirrors and the MEMS actuators are provided in the form of an N×N matrix to correspond to the input and output terminal optical fibers.

13. The fabrication method of an optical switch according to claim 10, wherein the MEMS actuators comprise comb actuators.
